(19) United States
(12) Patent Application Publication
(10) Pub. No.: US 2002/0142836 A1
(43) Pub. Date: Oct. 3, 2002

(54) Game apparatus, game control method, and recording medium and computer program therefor

(75) Inventor: Takayoshi Nakazato, Tokyo (JP)

Correspondence Address: GREENBLUM & BERNSTEIN, P.L.C., 1941 ROLAND CLARKE PLACE, RESTON, VA, 20191, US

(73) Assignee: SQUARE CO., Ltd., Tokyo (JP)

(21) Appl. No.: 09/968,972

(22) Filed: Oct. 3, 2001

(30) Foreign Application Priority Data
Mar. 29, 2001 (JP) 2001-096720

(51) Int. Cl. A63F 13/00

(52) U.S. Cl. 463/33

(57) ABSTRACT

A game apparatus and a game control method for controlling three-dimensional movements by simple and reliable operations. In response to a movement designation input of a character, the screen is moved independently of the direction, in which an operated character faces, in a direction designated by an operation key from the screen being displayed when the game character moves in water. At the movement controlling time in three-dimensions, as in the movement control of the character in water, the character dives downward while an X-button is being depressed, and dives upward while the X-button is being not depressed.

The present disclosure relates to subject matter contained in Japanese Patent Application No. 2001-096720, filed on Mar. 29, 2001, the disclosure of which is expressly incorporated herein by reference in its entirety.

### BACKGROUND OF THE INVENTION

1. Field of the Invention

The present invention relates to a game apparatus and a game control method for progressing a game in accordance with a game program, and a recording medium and a computer program for the apparatus and the method.

2. Description of Related Art

In recent years, RPG (Role Playing Game) is known as one game genre in a video game. In RPG, the operated game character (as will be called the “own character”) to be operated by the player grows by experiencing a meeting or departure with a partner character or a fight against a hostile character (as will be called the “enemy character”).

On the other hand, the player collects a variety of information in a virtual world, as provided by the game, through the own character and stores knowledge according to the collected informations. At the same time, the player grows by executing a variety of events to solve the mysteries and secrets of the world. Thus, the RPG generally indicates the game having the growing factors of the own character and the story.

Meanwhile, the player experiences the various events. In the game, there are prepared select branches for the individual fields so that the game contents are different depending upon what select branch is to be selected for the game.

Thus, the game progresses according to the selected branch and ends when the final target is cleared by overcoming the various difficulties.

The own character is operated by an operation unit having operation buttons and a direction designation lever (or stick). In the control by the stick, for example, the character advances in the direction in which the stick lever is brought down. On the other hand, the own character advances in the direction in which a direction key (e.g., a cross key), designating the movement in one of four upward, downward, leftward and downward directions, is depressed.

When this movement is designated forward, for example, the own character is moved in its facing direction. When the movement is designated rightward, the direction is changed rightward, as viewed from the own character, so that the own character is moved in the changed direction. When the movement is designated leftward, the direction is changed leftward, as viewed from the own character, so that the own character is moved in the changed direction. When the movement is designated backward, the own character is turned backward and is moved in the changed direction.

On the other hand, there is also a game in which the own character can move in water. In the water, there are added the motions in which the own character swims upward when the stick is slightly brought down simultaneously as the movement is instructed on the ground and in which the own character dives downward when the stick is depressed.

Accordingly, the game in which the character moves automatically, the character acts to dive into the water when a specific button, such as a brake button, is depressed while the character is on the water.

If the movements of the character are repeated, the directions of the character are frequently changed to disable the operator to discriminate what direction the character is moving in, so that the player moves in an unexpected direction.

Moreover, in the movement in the water, the operation requires a delicate feel to make the character dive upward, by slightly inclining the stick, while moving the character downward when the stick is strongly depressed. This complicates the operations so that erroneous operations cannot be avoided.

### SUMMARY OF THE INVENTION

The present invention has been conceived in view of the problems thus far described and has an object to provide a game apparatus and a game control method, which can solve the aforementioned problems and can operate the own character simply and reliably. In order to achieve this object, according to the invention, there are provided the following constructions.

There is provided a game apparatus for executing a game according to a game program, comprising: an operation unit that includes a direction designation button for designating the moving direction of at least a game character; and a character movement control device that moves the entire display screen, on which the game character is displayed, independently of the direction of said game character in accordance with the designation direction of the direction designation button of said operation unit.

For example, the character movement control device controls the display position of the game character in the game screen to the central portion.

Moreover, the operation unit further includes a specific button that designates the movement in one of an upward direction and a downward direction. The game character can move in a three-dimensional moving space, and the character movement control device continues, when the game character moves in the three-dimensional space, the movement in one of the upward and downward directions while the specific button of the operation unit is being depressed, and the movement in the other direction while the specific button is being released.

Moreover, the three-dimensional space is an underwater moving space, and said character movement control device continues, when the game character moves in the water, the movement in the downward direction while the specific button of the operation unit is being depressed, and the movement in the upward direction while the specific button is being released.

There is provided a game apparatus for executing a game according to a game program, comprising: an operation unit for designating a moving direction of a game character; and a character movement control device that moves the game character in a game field in accordance with the operation of the operation unit, wherein the operation unit includes: a direction designation button that designates the movement of the game character in the game field; and a specific button that designs the movement in one of an upward direction and a downward directions, and wherein the character movement control device moves the game character in a designated direction in the game field in accordance with the operation input of the direction designation means of the operation unit, and continues, in the case of the game field in which the game character can move in the three-dimensional space, the movement in one of the upward and downward directions while the specific button of the operation unit is being depressed, and the movement in the other direction while the specific button is being released.

Moreover, the three-dimensional space is an underwater moving space, and the character movement control device continues, when the game character moves in the water, the movement in the downward direction while the specific button of the operation unit is being depressed, and the movement in the upward direction while the specific button is being released.

There is further provided a game control method for a game apparatus having an operation unit including a direction designation button for designating the moving direction of at least a game character to execute a game according to a game program, wherein the entire display screen, on which the game character is displayed, is moved independently of the direction of the game character in accordance with the designation direction of the direction designation button of the operation unit.

There is further provided a computer program readable in and executable by a game apparatus having an operation unit including: a direction designation button for designating the movement of said game character in the game field; and a specific button for designating the movement in one of an upward direction and downward direction, for executing a game according to a game program, comprising: a character movement control step that moves the game character in a designated direction in the game field in accordance with the operation input of the direction designation device of the operation unit, and continuing, in the case of the game field in which the game character can move in the three-dimensional space, the movement in one of the upward and downward directions while the specific button of the operation unit is being depressed, and the movement in the other direction while the specific button is being released.

Alternatively, there is provided a computer-readable recording medium readable in and executable by a game apparatus having an operation unit including a direction designation button for designating the moving direction of at least a game character, wherein the computer-readable recording medium records a character movement control program string to move the entire display screen, on which the game character is displayed, independently of the direction of the game character in accordance with the designation direction of the direction designation button of the operation unit.

For example, the character movement control program string controls the display position of the game character in the game screen to the central portion.

For example, the operation unit further includes a specific button for designating the movement of one of an upward direction and a downward direction. The game character can move in a three-dimensional moving space, and the character movement control program string continues, when the game character moves in the three-dimensional space, the movement in one of the upward and downward directions while the specific button of the operation unit is being depressed, and the movement in the other direction while the specific button is being released.

For example, the three-dimensional space is an underwater moving space, and the character movement control program string continues when the game character moves in the water, the movement in the downward direction while the specific button of the operation unit is being depressed, and the movement in the upward direction while the specific button is being released.

There is further provided a computer-readable recording medium readable in and executable by a game apparatus having an operation unit including: a direction designation button for designating the movement of the game character in the game field; and a specific button for designating the movement in one of an upward direction and a downward direction, comprising: a character movement control step of moving said game character in a designated direction in the game field in accordance with the operation input of the direction designation the of the operation unit, and continuing, in the case of the game field in which the game character can move in the three-dimensional space, the movement in one of the upward and downward directions while the specific button of the operation unit is being depressed, and the movement in the other direction while said specific button is being released.

For example, the three-dimensional space is an underwater moving space, and the character movement control program string continues, when the game character moves in the water, the movement in the downward direction while the specific button of the operation unit is being depressed, and the movement in the upward direction while the specific button is being released.

### BRIEF DESCRIPTION OF THE DRAWINGS

FIG. 1 is a block diagram showing the entire construction of a game system according to one embodiment of the invention;

FIGS. 2A and 2B are diagrams for explaining one example of an input unit of the embodiment;

FIG. 3 is a schematic diagram showing a construction of a network game system for providing a network corresponding type game service of the embodiment;

FIG. 4 is a diagram for explaining a detailed construction of a CD-ROM of the embodiment;

FIG. 5 is a diagram showing a memory construction of a main memory of the embodiment shown in FIGS. 2A and 2B;

FIG. 6 is a flow chart for explaining the execution control of an RPG of the present embodiment;

FIG. 7 is a diagram for explaining an underwater control example by a specific button of the embodiment; and

FIG. 8 is a diagram for explaining a movement control example of a game character of the embodiment.

### DESCRIPTION OF THE PREFERRED EMBODIMENTS

One embodiment of the invention will be described in detail with reference to the accompanying drawings. The description will be made on the case in which the invention is applied to a game apparatus and in which a specific game is exemplified by a RPG. However, the invention is not limited to the RPG but is equally applicable to a game such as an action game, or a table game, as might be executed in real time with another game machine.

[First Embodiment]

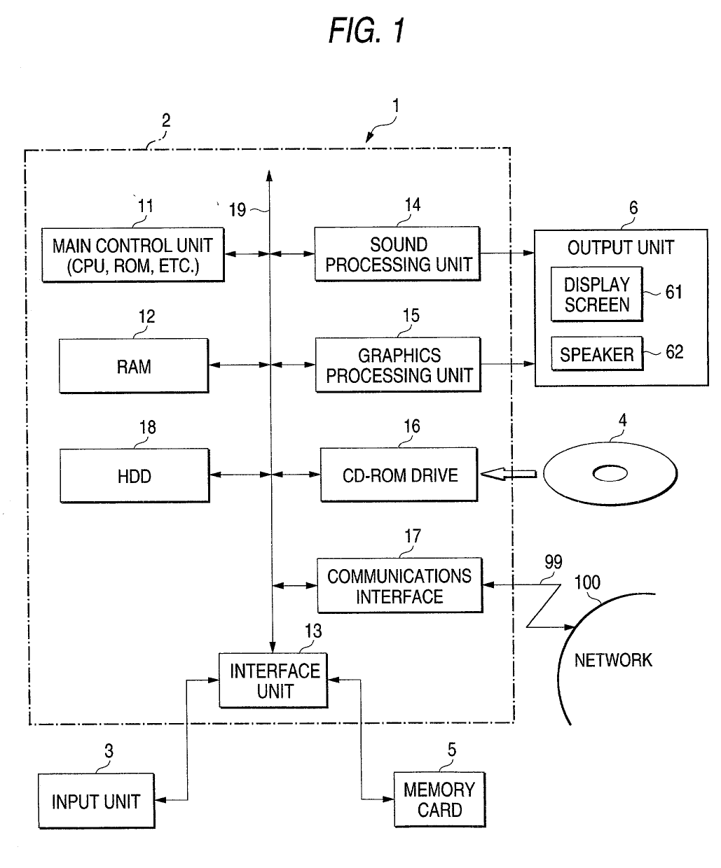

FIG. 1 is a block diagram showing the entire structure of a game system according to one embodiment of the invention. A game apparatus 1 is constructed to include: a game apparatus body 2 having the major functions of the game apparatus 1; an input unit (including, for example, a keypad or a controller) 3 that is used to input instructions to the operations of the game apparatus body 2; a memory card 5 for storing game data, such as the intermediate data or the environment setting data of a game; and an output unit (including, for example, a monitor display and a speaker) 6 for displaying video images or outputting sounds according to game contents on the basis of video signals or audio signals from the game apparatus body 2.

Moreover, the game apparatus body 2 is loaded with a CD-ROM (Compact Disk Read Only Memory) 4 for storing programs, image data or sound data for realizing operations for the later-described game.

The game apparatus body 2 is provided with a main control unit 11 having a CPU (Central Processing Unit) or a ROM (Read Only Memory) packaged therein; a RAM (Random Access Memory) 12; an interface unit 13; a sound processing unit 14; a graphics processing unit 15; a CD-ROM drive 16 having the CD-ROM 4 removably loaded thereon for accessing to its contents; a communications interface 17 for data communications with another game machine through a communications medium (or network) 100; an HDD (Hard Disk Drive) 18; and a bus 19 for connecting the foregoing individual components with each other.

The main control unit 11 is equipped with an oscillator and a timer counter (although both are not shown) for creating clock signals on the basis of timing signals, as outputted for every predetermined periods from the oscillator, to measure the time by counting the clock signals with the timer counter.

The RAM 12 is a main storage unit to be used for the CPU of the main control unit 11 to execute the programs and is stored with the programs to be executed by the CPU and the data necessary for the execution. Moreover, the RAM 12 is also used as a work area for the program execution time.

The interface unit 13 is so constructed that it can removably connect the input unit 3 and the memory card 5. The interface unit 13 controls the data transfers between the individual portion (mainly the main control unit 11) connected with the bus 19 and the input unit 3 or the memory card 5.

The sound processing unit 14 is a circuit for reproducing audio data, such as, for example, BGM (Back Ground Music) or effect sounds of the game. The sound processing unit 14 is instructed by the main control unit 11 to create voice signals on the basis of the data stored in the RAM 12 and to feed the voice signals to the output unit 6.

The graphics processing unit 15 is equipped with a (not-shown) frame buffer, and draws an image according to an instruction from the main control unit 11 on the frame buffer. Moreover, the graphics processing unit 15 creates video signals by adding predetermined synchronizing signals to the image data drawn on the frame buffer, and feeds the video signals to the output unit 6.

The CD-ROM drive 16 is a reading unit for reading out the data stored in the CD-ROM 4 or recording medium. The game apparatus 1 realizes the later-described controls on the game by causing the game apparatus body 2 to execute the controls according to the game programs recorded in the CD-ROM 4.

The communications interface 17 controls the communications at various data interchanges or associative games with another communications apparatus, such as, for example, a game apparatus connected with network 100. For example, the communications interface 17 controls an interchange of information (e.g., programs or data) between the game apparatus body 2 and the communications network 100. There can be stored in the HDD 18 the game programs and data which are downloaded from the external communications network 100 through the communications interface 17 and a communications line 99.

The HDD 18 is an auxiliary storage unit to be used for the CPU of the main control unit 11 to execute the programs. The HDD 18 can store various data or programs, such as, for example, the information downloaded by using the communications interface 17 or the information read out from the CD-ROM 4.

The CD-ROM 4 is stored with the programs, the image data and or the sound data for realizing the operations of the game, as described hereinbefore. The game programs contain those for the game apparatus 1 to execute the method according to the embodiment. The game software, as stored in the CD-ROM 4, starts the CD-ROM drive 16 to read the necessary game programs and game data, and actuates the main control unit 11 according to the programs read in.

The game software is pre-installed in the HDD 18. In accordance with an instruction from the main control unit 11, voice signals are created on the basis of the data stored in the RAM 12 and are fed to the output unit 6. Here, the game apparatus 1 can store the game software in the HDD 18, too.

As noted above, graphics processing unit 15 is equipped with the (not-shown) frame buffer, and draws the game image on the frame buffer in accordance with the control of the main control unit 11. Moreover, the graphics processing unit 15 creates video signals by adding predetermined synchronizing signals to the image data down on the frame buffer, and feed the video signals to the output unit 6.

The input unit 3 is equipped with controllers which are operated by the player for inputting the various designations on the game to the game apparatus body 2. The input unit 3 sends command signals according to the operations to the game apparatus body 2 through the interface unit 13.

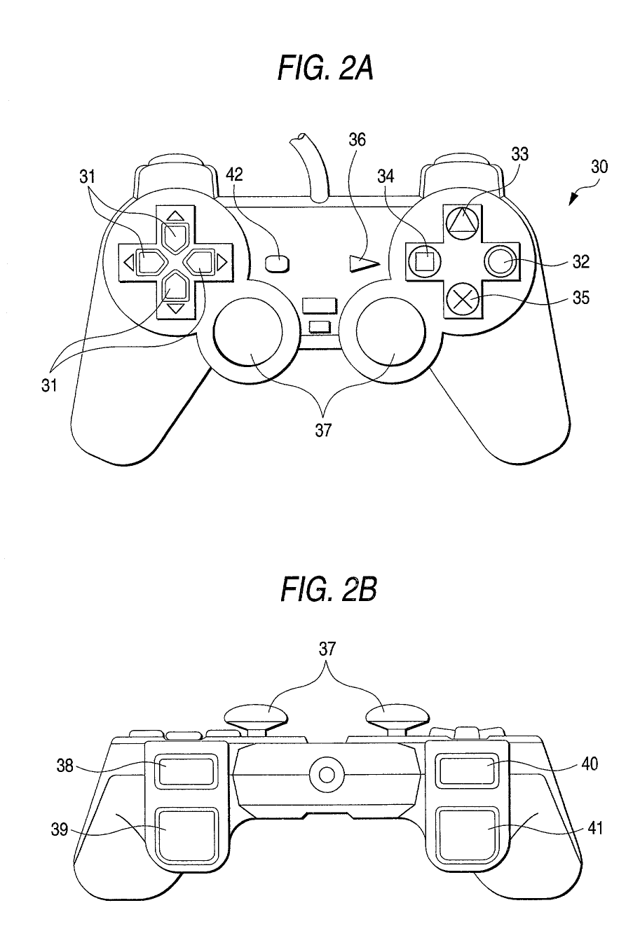

In this embodiment, a game progress designation is inputted by the controller. The following discussion will be made with respect to a case in which the input is made by a controller 30 acting as the input unit 3. A construction example of the controller as the input unit 3 in this embodiment is shown in FIGS. 2A and 2B. FIG. 2A and FIG. 2B are a top plan view and a back view, respectively, for explaining one example of the input unit of the embodiment.

In FIGS. 2A and 2B, the controller 30 is equipped with a cross key 31 for inputting the moving information or the like of a character, and a plurality of operation keys (including a ∘ button 32, a Δ button 33, a square button 34, an × button 35, a start button 36 and a select button 42) for designating/inputting various commands to the game apparatus body 2.

The controller 30 is further equipped with a joy stick 37 for inputting the moving informations. On the back of the controller 30, as shown in FIG. 2B, there are arranged a plurality of operation keys (e.g., an R1 button 38, an R2 button 39, an L1 button 40 and an L2 button 41).

All of the operation keys (excepting the start button 36 and the select button 42) are of the pressure-sensitive type. Moreover, the controller 30 has a vibration (or oscillation) function. Specifically, the controller 30 is provided therein with a motor which is activated, when it receives a predetermined control signal from the game apparatus body 2, to vibrate the controller 30 as a whole. As a result, vibrations can be transmitted to the player holding the controller 30.

The game apparatus body 2 can adjust the intensities of the vibrations, and is prepared for the vibration intensities of three stages of “High”, “Medium” and “Low”. The vibrations of the controller 30 may be intermittent, so that they can be controlled and generated randomly with any of the above-noted intensities.

The memory card 5 is an auxiliary memory unit which is made of a flash memory and controlled by the game apparatus body 2 to store the game data. The writing data in the memory card 5 and the reading of data from the memory card 5 are controlled by the main control unit 11 through the interface unit 13.

The output unit 6 displays the game image and outputs the voice on the basis of the video signals and the audio signals from the game apparatus body 2. In this embodiment, a monitor unit having a speaker packaged therein, such as a television (TV) set is prepared as the output unit 6. The monitor unit is equipped with an image display screen 61 and a voice outputting speaker 62.

The output unit 6 displays the image on the display screen 61 in response to the video signals from the graphics processing unit 15 and outputs the voice from the speaker 62 in response to the sound signals from the sound processing unit 14. Therefore, the output unit 6 functions as both the display unit and the voice output unit.

The main control unit 11 controls the actions of the game apparatus body 2 on the basis of the fundamental software stored in the ROM and the game software read out from the CD-ROM 4 by the CD-ROM drive 16 and stored in the RAM 12.

For example, the CPU 11 reads out the graphics data from the CD-ROM 4 and transfers them to the graphics processing unit 15 to designate an image to be created. In response to this designation, the graphics processing unit 15 creates the video signals with the graphics data. The video signals are sent to the output unit 6. As a result, the image is displayed on the display screen of the output unit 6.

The game apparatus 1 thus constructed according to this embodiment is enabled to communicate with another game apparatus through the network 100 and to play a network game in which players can participate through the network 100. In this case, the game programs can be not only read out from the CD-ROM 4 but also downloaded from another communications unit (or server unit) connected with the network.

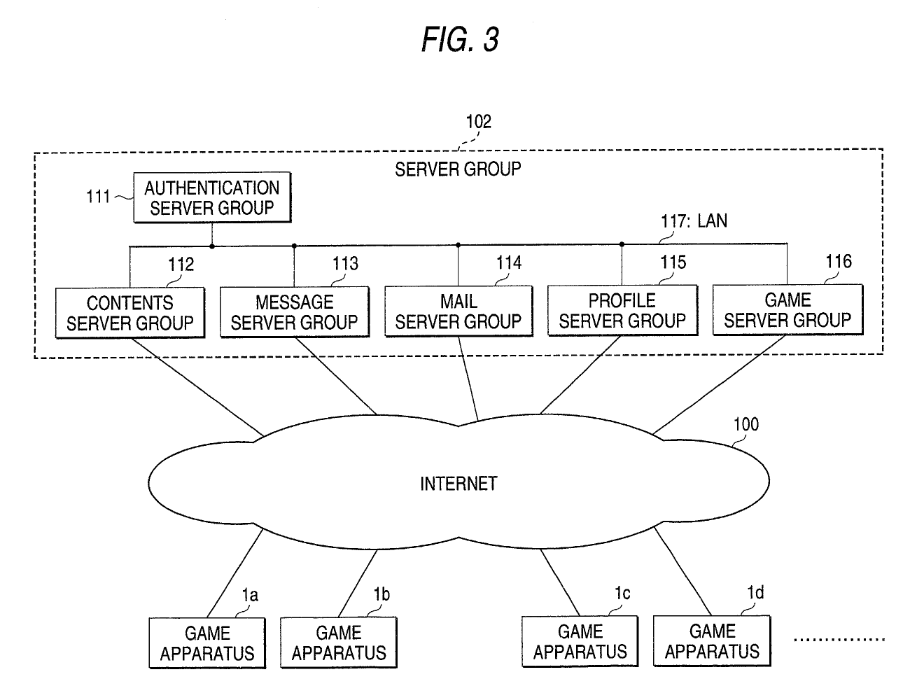

A construction of the network game system of the case in which the network game is executed by the foregoing functions will be described with reference to FIG. 3. FIG. 3 is a schematic diagram showing a construction of the network game system for providing network matching type game services of the embodiment.

In the network game system of this embodiment, game apparatus 1a, 1b, 1c and 1d having the construction shown in FIG. 1 are connected with a server group 102 through the network system of a communications medium, such as the internet 100. It is understood that, the number of game apparatus that may be connected to the internet 100 is not limited to that of the example shown in FIG. 3 by the game contents, and two or more arbitrary numbers may be connected to execute the game without departing from the scope and/or spirit of the invention.

A server group 102 is constructed, for example, to include: an authentication server group 111 for account administrations for a user authentication; a contents server group 112 for providing interfaces between the game apparatus 1 and other server groups and perusal services of contents such as, for example, voices or motion pictures; a message server group 113 for providing environments for chats or messages; a mail server group 114 for providing services of electronic mail; a profile server group 115 for administrating the profiles of the user; and a game server group 116 for providing game environments.

The server groups 111 to 116 are connected with each other through a LAN 117. The server groups are not limited in their construction to the aforementioned one, but may be either wholly constructed of one server or more finely divided to share one another.

The game server group 116 contains a lobby server for executing a game according to this embodiment. When the game apparatus 1 is connected with the lobby server, a screen indicating a virtual “lobby” is displayed on the display unit 6. On this lobby screen, there are displayed the play character of the player and the character of another player connected with the lobby server. The player can chat to make communications with another play or to find out a partner to play with.

In this embodiment, in addition to the chat message f6r displaying the character information inputted by the player in real time, a message selected by the player from predetermined candidates can be continuously displayed in the vicinity of the play character.

Next, there will be described the game programs or data which are read out from the CD-ROM 4 by the CPU of the main control unit 11 and stored in the RAM 12 or the main memory.

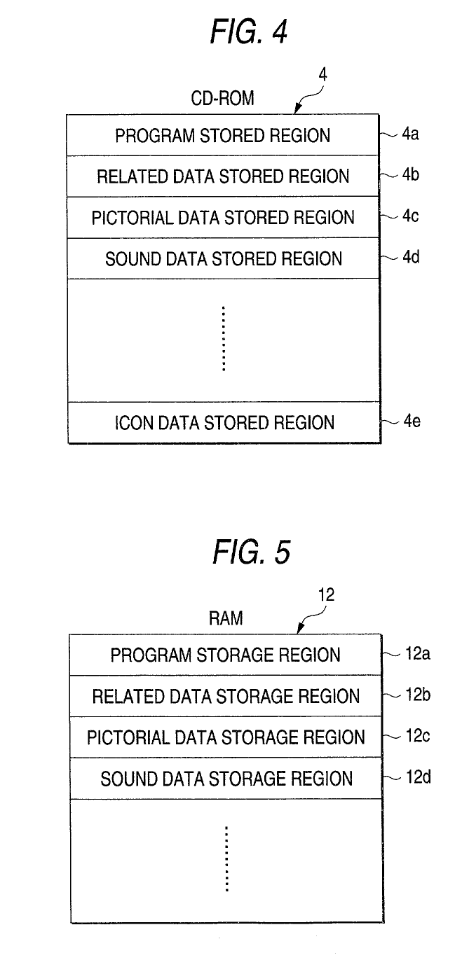

FIG. 4 is a diagram for explaining the stored contents and the storage regions of the CD-ROM 4.

As shown in FIG. 4, the CD-ROM 4 is constructed of a program storage region 4a for storing the game programs to be executed by the main control unit 11; a related data storage region 4b for storing the data necessary for progressing the various games; an image data storage region 4c for storing modeling data of three-dimensional models or two-dimensional image data to be used as backgrounds; a sound data storage region 4d for storing the sound data such as the effect sounds; and an icon data storage region 4e for storing icon informations intrinsic to the games, such as, for example, the characters to appear in the games.

In this embodiment, the individual data stored in the individual storage regions of the CD-ROM 4, the RAM 12 is loaded with a portion of the data necessary for progressing a game at a stage so that the game is progressed on the basis of the data loaded onto the RAM 12.

At an instant when next data become necessary for progressing the game, the RAM 12 is loaded with such data of the individual data stored in the individual storage regions of the CD-ROM 4 as will be needed for the game to progress.

While the network game is being executed, the game progress control is made on the basis of the control from the lobby server for executing the game of the game server group 116 in the server group 102. In accordance with the progress control by the lobby server, the partial data stored in the individual storage regions of the CD-ROM 4 and necessary for the game progress are loaded onto the RAM 12 so that the game is progressed on the basis of the data loaded onto the RAM 12.

Here will be described the programs and data which are read out from the CD-ROM 4 and stored in the RAM 12 by the main control unit 11.

FIG. 5 is a diagram showing a memory construction of the RAM 12, As shown in FIG. 5, the RAM 12 is constructed of a program storage region 12a for storing the programs for the main control unit 11 to execute; a related data storage region 12b for storing the data necessary for the various operations to execute; an image data storage region 12c for storing the image data such as the modeling data of the three-dimensional models and the two-dimensional image data to be used as the backgrounds; and a sound data storage region 12d for storing the sound data, such as, for example, the effect sounds.

In this embodiment, the related data storage region 12b stores, when there are select branches for selecting two or more events for executing the various events at the later-described game executing time, with the select branch selecting informations on what select branch is selected for each player. This selecting informations is updated as the game progresses. At the game saving time, moreover, the selecting informations are saved in the memory card 5 and are written again in the RAM 12 when the game is executed again.

Even when the game progresses to the end with no problem, as will be detailed hereinafter, the select branch selecting informations are not erased but are reflected again on the game progress when the game is executed by the same player.

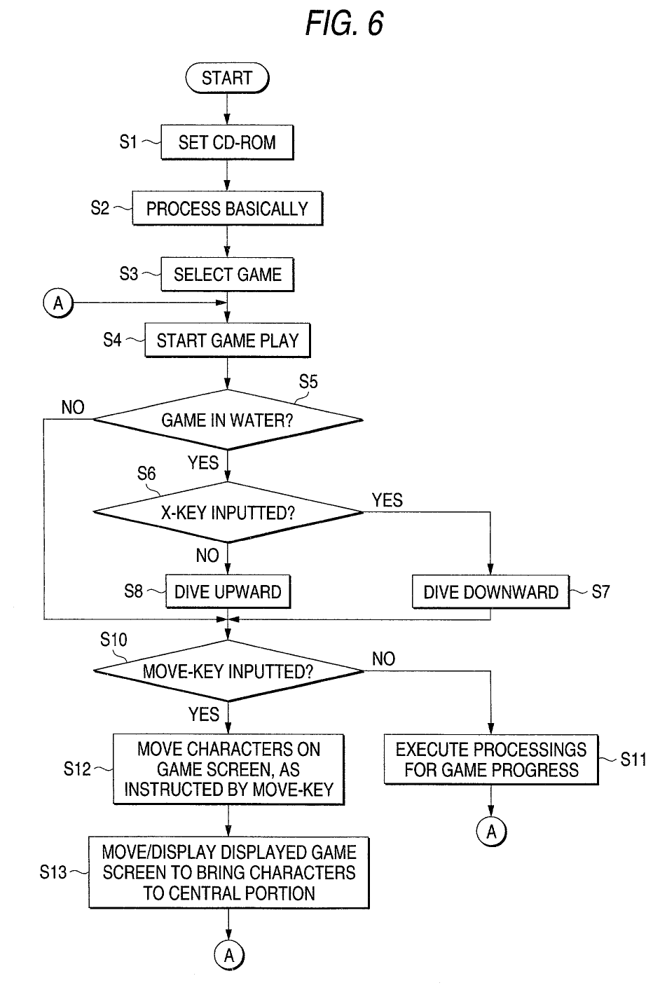

The controls of the RPG in this embodiment thus constructed will be described in the following with reference to the flow chart of FIG. 6. FIG. 6 is a flow chart for controlling the RPG of this embodiment. These operations are executed when the game apparatus body 2 executes the game programs stored in the CD-ROM 4.

At Step S1, as shown in FIG. 6, the game apparatus body 2 is set with the CD-ROM 4 recorded with the game programs. As a result, the routine advances to Step S2, at which the necessary programs are read out from the CD-ROM 4 and stored in the RAM 12 to perform the basic operations to display an initial screen (e.g., a maker logo), to check the memory card 5, to display a title screen and to load the data.

At Step S3, a game select screen, displayed at the end of the basic operations, is manipulated to select the game to be executed, such as what version of the game of the RPG game is to be executed. When the game is selected, the routine advances to Step S4, at which the selected game is started. This game is played associatively with the partner, when the game is a network game and when the partner is a player to operate another game machine through the network 100.

In every lapse of a predetermined time according to the progress of the game, when the controller 30 is operated or when the field changes, moreover, the routine advances to Step S5. At Step S5, it is decided whether or not the execution field of the game is in water. If the game field is not in the water, the routine advances to Step S10.

If it is decided at Step S5 that the game field is in the water, as exemplified by the case in which the operated character is in the water or water surface, the routine advances to Step S6, at which it is decided whether or not a specific button, such as the ×-button 35 of the controller 30, is inputted (depressed).

When it is decided at Step S6 that the ×-key 35 is inputted, the routine advances to Step S7, at which the operated character divs downward more deeply into the water. Then, the routine advances to Step S1.

When it is decided at Step S6 that the ×-key 35 has not been inputted, the routine advances to Step S8, at which the operated character dives upward toward the water surface. Then, the routine advances to Step S10. Here, where the operated character is on the water surface when the specific button begins to be depressed, the operated character cannot rise upward and is kept in a state floating in the water surface.

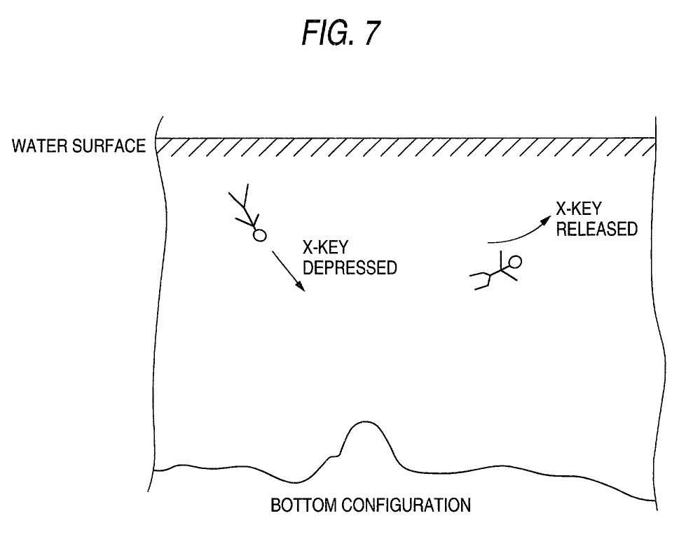

The underwater control of this embodiment by the specific button is shown in FIG. 7. As shown in FIG. 7, the character dives downward in the water, while the specific button (i.e., the ×-button 35) is being depressed, but dives upward toward the water surface while the specific button (i.e., the ×-button 35) is released.

At Step S10, moreover, it is decided whether or not the move-key (i.e., the cross key 31 and the joy stick 37 in this embodiment) for designating the movement of the operated character is operated. With no input from the move-key 31 or 37, the routine advances to Step S11, at which the game progressing operations necessary for the game scene are executed, after which, processing returns to Step S4. Where the scene becomes a battle scene, for example, the game is progressed in the battle mode.

When the move-key 31 or 37 is inputted at Step S10, the routine advances to Step S12. Independently of what direction the character might face in the game screen, the character advances a predetermined distance upward on the screen when the upward direction is designated by the move-key 31 or 37 or downward (to this side) of the screen when the downward direction is designated or rightward of the screen when the rightward direction is designated or leftward of the screen when the leftward direction is designated.

At Step S13, the game screen display is moved as the character moves. For example, the display of the game field is controlled to bring the operated character to a central portion of the screen. Processing then returns to Step S4.

The description has been made on the case in which the game screen is moved after the character was moved at first. However, this embodiment should not be limited to the aforementioned one but may be controlled, as follows. The game screen is moved according to the operation of the move-key, and the character is then brought to the central portion of the screen.

Alternatively, it is arbitrary to display the movement of the screen and the movement of the character simultaneously. With these simultaneous movements, the game screen can be displayed most naturally. Then, the routine returns to Step S4, the game is progressed.

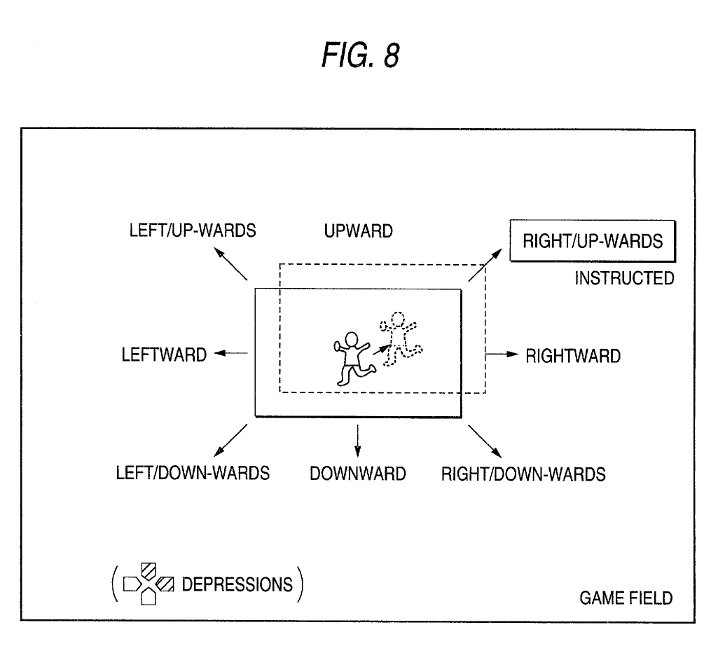

With reference to FIG. 8, there will be described the controls of the movements of the game characters of this embodiment. FIG. 8 is a diagram for explaining an example of the movement controls of the game characters of this embodiment. Where the region shown in FIG. 8 is one display region of the game field, it is assumed that the game screen display region in the actual display screen 61 before operated is defined by solid curved at the central portion.

In the game display screen on the display screen 61 shown in FIG. 8, according to this embodiment, the operated character is controlled and displayed at the central portion of the game screen on principles excepting the case in which the game screen is in the battle mode or in a specific event screen or in which the screen is in the varying course.

Even where the game character faces leftward of the screen, as shown in FIG. 8, the cross key 31 is controlled, for example, to depress both the upward bar and the rightward bar to designate the right/up-wards movement. The game screen then moves not right/up-wards, as seen from the character, but right/up-words of the game display screen so that the game screen region is displayed, as shown by broken lines. As a result, the character is treated, as if it moves right/up-wards.

When the upward bar portion of the cross key 31 is depressed, the display game screen region moves upward. Even when the rightward bar is depressed, the character moves not rightward but rightward of the game screen on the back, as viewed from the character.

According to this embodiment, as has been described hereinbefore, the screen is moved independently of the direction, in which the operated character faces, but in the direction designated by the operation key from the display being designated. As a result, the direction of the screen is not easily changed according to the direction of the character so that the game progress can be reliably controlled as to prevent the character from disappearing from the game field.

Especially in the three-dimensional movement control as in the movement control of the character in the water, it is difficult to grasp the moving direction of the character. Therefore, the movement control can be made independently of the direction of the character in the game screen but with reference to the game display screen which can be confirmed most easily by the player, so that the game can be progressed to move the character easily to the will of the player.

Moreover, the upward/downward control in the water can be made not by the direction designation key but by the specific button (e.g., the ×-button 35 in this embodiment). Therefore, the underwater control can be made by the simple and reliable operations unlike the prior art which requires complicated operations and the skills, in which not only the movement control of the character but also the upward/downward underwater control is assigned to the direction designation key so that the direction control designation or the upward/downward underwater control is selected by the degree of key operation.

[Another Embodiment]

Although the invention has been specifically described in connection with its embodiment and its modification, it should not be limited thereto but could naturally be suitably modified without departing from the gist thereof.

For example, the event to be selected is the direction in which the operated character advances but may be an item or an operation such as a lever operation. Moreover, the event may be what of the item held is to be used or placed, or a selection of a partner character or an action.

In the description thus far made, moreover, the complete end of a preceding game execution is reflected on a next game. However, the invention should not be limited to the foregoing embodiment but may be a clearance of each stage or a reflection of the preceding selection on the cleared stage.

Even in the execution of a game, moreover, the clearance result may be controlled to reflect at the field unit. When the game progress of the field once cleared is attacked again, for example, the selection result of the preceding game progress may be reflected on the next game progress.

For example, the foregoing embodiment and its embodiment have been described on the case in which the invention is exemplified by realizing the home game machine as the platform. However, the invention may be exemplified by realizing the general-purpose computer, e.g., the personal computer or the arcade game machine as the platform.

In the foregoing embodiment and its modification, on the other hand, the programs and data for realizing the invention are stored in the CD-ROM, and this CD-ROM is used as the information recording medium. However, this information recording medium should not be limited to the CD-ROM but might be another computer-readable magnetic or optical recording medium such as a magnetic disk or a ROM card, or a semiconductor memory.

On the other hand, the programs or data for realizing the invention should not be limited to the mode in which they are provided by the media such as the CD-ROM loaded onto or unloaded out of the game machine or the computer. However, the save data for realizing the invention might be exemplified by the mode in which they are received from another device such as the server group connected through the communications line and are recorded in the memory. The mode may also be so modified that the programs or data are recorded in a memory on the side of another device connected through the communications line and are used through the communications line.

According to this embodiment, as has been described hereinbefore, the screen is moved independently of the direction, in which the operated character faces, but in the direction designated by the operation key from the display being designated. As a result, the direction of the screen is not easily changed according to the direction of the character so that the game progress can be reliably controlled as to prevent the character from disappearing from the game field.

Especially in the three-dimensional movement control as in the movement control of the character in the water, it is difficult to grasp the moving direction of the character. Therefore, the movement control can be made independently of the direction of the character in the game screen but with reference to the game display screen which can be confirmed most easily by the player, so that the game can be progressed to move the character easily to the will of the player.

Moreover, the upward/downward control in the water can be made not by the direction designation key but by the specific button. Therefore, the three-dimensional movement control can be made by the simple and reliable operations unlike the prior art which requires complicated operations and the skills.

What is claimed is:

1. A game apparatus for executing a game according to a game program, comprising:
an operation unit that includes a direction designation button that designates a moving direction of at least a game character; and
a character movement control device that moves an entire display screen, on which said game character is displayed, independently of a direction of said game character in accordance with a designation direction by said direction designation button of said operation unit.

2. A game apparatus according to claim 1,
wherein said character movement control device controls a display position of said game character in a game screen to a central portion.

3. A game apparatus according to claim 1,
wherein said operation unit further includes a specific button that designates a movement of at least one of an upward direction and a downward direction,
wherein said game character is selectively movable in a three-dimensional moving space, and
wherein said character movement control device continues, when said game character moves in said three-dimensional space, the movement in one of the at least one of said upward direction and said downward direction while the specific button of said operation unit is being depressed, and the movement in the other direction while said specific button is being released.

4. A game apparatus according to claim 3,
wherein said three-dimensional space comprises an underwater moving space, and
wherein said character movement control device continues, when said game character moves in the water, the movement in the downward direction while the specific button of said operation unit is being depressed, and the movement in the upward direction while said specific button is being released.

5. A game apparatus for executing a game according to a game program, comprising:
an operation unit that designates a moving direction of a game character; and
a character movement control device that moves said game character in a game field in accordance with an operation of said operation unit,
wherein said operation unit includes a direction designation button for designating a movement of said game character in the game field, and a specific button for designating a movement in one of an upward direction and a downward direction, and
wherein said character movement control means moves said game character in a designated direction in said game field in accordance with the operation input of the direction designation means of said operation unit, and continues, in the case of the game field in which said game character can move in the three-dimensional space, the movement in one of the upward and downward directions while the specific button of said operation unit is being depressed, and the movement in the other direction while said specific button is being released.

6. A game apparatus according to claim 5,
wherein said three-dimensional space comprises an underwater moving space, and
wherein said character movement control device continues, when said game character moves in the water, the movement in said downward direction while the specific button of said operation unit is being depressed, and the movement in said upward direction while said specific button is being released.

7. A game control method for a game apparatus having an operation unit including a direction designation button for designating a moving direction of at least a game character to execute a game according to a game program,
wherein the entire display screen, on which the game character is displayed, is moved independently of the direction of the game character in accordance with a designation direction of the direction designation button of the operation unit.

8. A game control method according to claim 7,
wherein the display position of said game character in the game screen is controlled to the central portion.

9. A game control method according to claim 7,
wherein the operation unit further includes a specific button for designating the movement of one of the upward direction and the downward direction,
wherein the game character can move in a three-dimensional moving space, and
wherein when the game character moves in the three-dimensional space, the movement in one of the upward direction and the downward direction is continued while the specific button of the operation unit is being depressed, and the movement in the other direction is continued while the specific button is being released.

10. A game control method according to claim 9,
wherein the three-dimensional space is an underwater moving space, and
wherein when the game character moves in the water, the movement in the downward direction is continued while the specific button of the operation unit is being depressed, and the movement in the upward direction is continued while the specific button is being released.

11. A game control method for a game apparatus having an operation unit including a direction designation button that designates a movement of a game character in a game field, and a specific button for designating a movement in one of an upward direction and a downward direction, for executing a game according to a game program,
wherein the game character is moved in a designated direction in the game field in accordance with the operation input of the direction designation device of the operation unit, and, in the case of the game field in which the game character is selectively moved in the three-dimensional space, the movement is continued in one of the upward direction and the downward direction while the specific button of the operation unit is being depressed, and the movement is continued in the other direction while the specific button is being released.

12. A game control method according to claim 11,
wherein the three-dimensional space comprises an underwater moving space, and
wherein when the game character moves in the water, the movement in the downward direction is continued while the specific button of the operation unit is being depressed, and the movement in the upward direction is continued while the specific button is being released.

13. A computer program readable in and executable by a game apparatus having an operation unit including a direction designation button for designating the moving direction of at least a game character, comprising:
a character movement control operation that moves an entire display screen, on which the game character is displayed, independently of the direction of the game character in accordance with the designation direction of the direction designation button of the operation unit.

14. A computer program according to claim 13,
wherein the character movement control operation controls the display position of the game character in the game screen to a central portion.

15. A computer program according to claim 13,
wherein the operation unit further includes a specific button that designates a movement of one of an upward direction and a downward direction,
wherein the game character selectively moves in a three-dimensional moving space, and
wherein the character movement control operation continues, when the game character moves in the three-dimensional space, the movement in one of the upward direction and the downward direction while the specific button of said operation unit is being depressed, and the movement in a remaining direction of the upward direction and the downward direction while said specific button is being released.

16. A computer program according to claim 15,
wherein the three-dimensional space comprises an underwater moving space, and
wherein the character movement control operation continues when the game character moves in the water, the movement in the downward direction while the specific button of the operation unit is being depressed, and the movement in the upward direction while the specific button is being released.

17. A computer program readable in and executable by a game apparatus having an operation unit including a direction designation button that designates a movement of a game character in a game field, and a specific button that designates a movement of the game character in one of an upward direction and a downward direction, for executing a game according to a game program, comprising:
a character movement control operation that moves the game character in a designated direction in the game field in accordance with an operation input of the direction designation device of the operation unit, and continuing, in the case of the game field in which the game character can move in the three-dimensional space, the movement in one of the upward direction and the downward direction while the specific button of said operation unit is being depressed, and the movement in a remaining direction of the upward direction and the downward direction while the specific button is being released.

18. A computer program according to claim 17,
wherein the three-dimensional space comprises an underwater moving space, and
wherein the character movement control operation continues, when the game character moves in the water, the movement in the downward direction while the specific button of the operation unit is being depressed, and the movement in the upward direction while the specific button is being released.

19. A computer-readable recording medium readable in and executable by a game apparatus having an operation unit including a direction designation button that designates a moving direction of at least a game character,
wherein the computer-readable recording medium records a character movement control program string to move the entire display screen, on which the game character is displayed, independently of a direction of the game character in accordance with a designation direction of the direction designation button of the operation unit.

20. A computer-readable recording medium according to claim 19,
wherein the character movement control program string controls a display position of the game character in a game screen to a central portion.

21. A computer-readable recording medium according to claim 19,
wherein the operation unit further includes a specific button that designates a movement of one of an upward direction and a downward direction,
wherein the game character selectively moves in a three-dimensional moving space, and
wherein the character movement control program string continues, when the game character moves in the three-dimensional space, the movement in one of the upward direction and the downward direction while the specific button of the operation unit is being depressed, and the movement in a remaining direction of the upward direction and the downward direction while the specific button is being released.

22. A computer-readable recording medium according to claim 21,
wherein the three-dimensional space comprises an underwater moving space, and
wherein the character movement control program string continues when the game character moves in the water, the movement in the downward direction while the specific button of the operation unit is being depressed, and the movement in the upward direction while the specific button is being released.

23. A computer-readable recording medium readable in and executable by a game apparatus having an operation unit that includes a direction designation button that designates a movement of the game character in a game field, and a specific button that designates a movement in one of an upward direction and a downward direction, comprising:
a character movement control operation that moves the game character in a designated direction in the game field in accordance with an operation input of a direction designation device of the operation unit, and continuing, in the case of the game field in which the game character selectively moves in the three-dimensional space, the movement in one of an upward direction and a downward direction while the specific button of said operation unit is being depressed, and the movement in a remaining direction of the upward direction and the downward direction while the specific button is being released.

24. A computer-readable recording medium according to claim 23,
wherein the three-dimensional space is an underwater moving space, and
wherein the character movement control program string continues, when the game character moves in the water, the movement in the downward direction while the specific button of the operation unit is being depressed, and the movement in the upward direction while the specific button is being released.
